(19) United States
(12) Patent Application Publication
(10) Pub. No.: US 2008/0209449 A1
(43) Pub. Date: Aug. 28, 2008

(54) Setting Device For Setting Allocation Information Of Setting Item In Setting Screen Of Device Driver

(75) Inventor: Hirotoshi Maehira, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/038,749

(22) Filed: Feb. 27, 2008

(30) Foreign Application Priority Data
Feb. 27, 2007 (JP) 2007-047996

(51) Int. Cl. G06F 9/44

(52) U.S. Cl. 719/321

(57) ABSTRACT

A setting device for setting allocation information of a setting item allocated in a setting screen of a device driver, the setting screen being adapted for altering a controlling condition of a target device. At an administrator terminal, allocation information setting application is activated upon execution of allocation information setting program. In a setting item edit screen displayed in a monitor, a list of setting items displayed at an allocated setting item display area or an unallocated setting item display area is dragged and dropped in a setting screen displayed at setting screen display area, whereupon the dragged setting item is allocated in currently displayed setting screen.

### CROSS REFERENCE TO RELATED APPLICATION

This application claims priority from Japanese Patent Application No. 2007-047996 filed Feb. 27, 2007. The entire content of the priority application is incorporated herein by reference.

### TECHNICAL FIELD

The present invention relates to a setting device for setting, allocation information of a controller(setting item) allocated in a setting screen of a device driver.

### BACKGROUND

In the device driver, a plurality of setting screens are provided, and the setting screen is adapted for altering a control condition of a device such as a printer and a scanner. At present, a device driver which is a program for controlling the device such as a printer and a scanner must be installed in the information processing device such as a personal computer in order to make use of the device through the information processing device. Then, the information processing device controls the device through the installed device driver.

The device driver generally includes a setting screen (including an install screen displayed when the driver is installed) for setting a control condition of the device when the user uses the device. For example, a printer driver as a type of the device driver includes a setting screen for setting a connection system with a printer and a print condition (that is, a feeder, a type of sheet, and a type of ink (color/monochrome)). In this manner, the user can select and set a desired control condition on the setting screen, and can carry out printing with the printer in accordance with the set control condition.

However, in recent years, control conditions which can be set by the device driver have varied and become complicated. Therefore, for example, when the device driver is supplied to a number of personal computers in a company, an administrator has set to hide a part of controllers (or setting items displayed on the setting screen) considered unnecessary in each department in advance as described in laid-open Japanese Patent Application Publication No. 2006-172183. In this manner, setting item that is determined to be unnecessary for the user can be hidden from the setting screen of the device driver in advance, and usability can be improved.

Here, in the device driver having a number of setting items, all of the setting items cannot be allocated in one setting screen. Therefore, as in a conventional manner, each of the setting items has been classified into a plurality of groups, allocated in different setting screens depending on the classified groups, and displayed by switching the setting screens. However, in a conventional setting item setting method described in the above-described JP publication, switching of “visibility and hidden” with respect to the setting item has always been carried out for each of the setting screens. Therefore, allocation of setting items cannot be changed among the plurality of the setting screens. That is, with respect to a setting item belonging to a specific setting screen, the setting item can be switched to be “visibility and hidden” in the specific setting screen. However, the setting item cannot be allocated in other setting screens.

However, an administrator side desires to set a setting item considered to be frequently used by the user in a setting screen most frequently displayed among a plurality of setting screens. On the other hand, a setting item that is considered to have been scarcely used by the user are desirably set to be allocated on a unpopular setting screen among the plurality of the setting screen, the unpopular setting screen being only displayable by switching operation by the user.

### SUMMARY

It is therefore an object of the present invention to provide a setting device enabling changing, at an administrator side, of allocation of setting items (or controllers) among or between a plurality of setting screens in a device driver, thereby facilitating usability.

This and other object will be attained by a setting device for setting, in a device driver provided with a plurality of setting screens each changing a control condition of a targeting device, allocation information of a setting item to be allocated in one of the setting screens. The setting device includes allocation information storing part, setting screen display control part, setting item allocating part, unallocated setting item selecting part, and allocation information updating part. The allocation information storing part stores allocation information of a setting item to be allocated in any of the plurality of setting screens. The setting screen display control part displays any of the plurality of setting screens in a display region. The setting item allocating part allocates the setting item in the setting screen displayed in the display region in accordance with the stored allocation information of the setting item. The unallocated setting item selecting part selects a setting item not allocated in the displayed setting screen. The allocation information updating part updates allocation information of the setting item selected by the unallocated setting item selecting part to a new allocation information for allocating the selected setting item in the displayed setting screen. Allocation information of the setting item to be allocated in the setting screen of the device driver is set based on the updated allocation information.

In another aspect, there is provided a storage medium storing a set of program instructions installable in a computer, the program instruction setting, in a device driver provided with a plurality of setting screens each changing a control condition of a targeting device, allocation information of a setting item to be allocated in one of the setting screens. The set of program instructions includes allocation information storing routine that stores allocation information of a setting item to be allocated in any of the plurality of setting screens, setting screen display control routine that displays any of the plurality of setting screens in a display region, setting item allocating routine that allocates the setting item in the setting screen displayed in the display region in accordance with the stored allocation information of the setting item, unallocated setting item selecting routine that selects a setting item not allocated in the displayed setting screen, and allocation information updating routine that updates allocation information of the setting item selected by the unallocated setting item selecting routine to a new allocation information for allocating the selected setting item in the displayed setting screen, allocation information of the setting item to be allocated in the setting screen of the device driver being set based on the updated allocation information.

### BRIEF DESCRIPTION OF THE DRAWINGS

In the drawings;

FIG. 1 is a schematic perspective view of a print management system according to a first embodiment of the present invention;

FIG. 2 is a schematic perspective view of an administrator terminal in the print management system according to the first embodiment;

FIG. 3 is a block diagram of an electrical arrangement of the administrator terminal according to the first embodiment;

FIG. 4 is a view illustrating a setting item edit screen displayed on a monitor for execution of an allocation information setting application by the administrator terminal according to the first embodiment;

FIG. 5 is a flowchart showing an allocation information setting process executed in the administrator terminal according to the first embodiment;

FIG. 6 is a flowchart showing a mouse left button click processing executed in the administrator terminal according to the first embodiment;

FIG. 7 is a flowchart showing drag-and-drop processing executed in the administrator terminal according to the first embodiment;

FIG. 8 is a flowchart showing a mouse right button click processing executed in the administrator terminal according to the first embodiment;

FIG. 9 is a flowchart showing setting item menu processing executed in the administrator terminal according to the first embodiment;

FIG. 10 is a flowchart showing tab menu processing executed in the administrator terminal according to the first embodiment;

FIG. 11 is a flowchart showing list menu processing executed in the administrator terminal according to the first embodiment;

FIG. 12 is a view showing a setting item edit screen in a default state according to the first embodiment;

FIG. 13 is a view showing the setting item edit screen after a setting item of “Layout” in the setting item edit screen shown in FIG. 12 is dragged to and dropped at an unallocated setting item display area in the first embodiment;

FIG. 14 is a view showing the setting item edit screen after a setting item of “Sheet Size” in the setting item edit screen shown in FIG. 13 is dragged to and dropped at a lower position in the same setting screen in the first embodiment;

FIG. 15 is a view showing the setting item edit screen after a list of “Color/Monochrome” allocated under “Advanced Settings Tab” of the allocated setting item display area in the setting item edit screen shown in FIG. 14 is dragged to and dropped in a free space above the setting item of “Sheet Size” in the setting screen in the first embodiment;

FIG. 16 is a view showing a setting item table in a default state corresponding to FIG. 12;

FIG. 17 is a view showing a setting item table in a custom state corresponding to FIG. 15;

FIG. 18 is a view showing a tab table in its default state in the first embodiment;

FIG. 19 is a view showing the tab table in its custom state in the first embodiment;

FIG. 20 is a view of a setting item edit screen of an allocation information setting application executed in an administrator terminal according to a second embodiment of the present invention; and

FIG. 21 is a view of setting item edit screen in which a setting item of “Layout” is dragged and dropped in unallocated setting item display area in the setting item edit screen shown in FIG. 20.

In the illustrated flowcharts, the term “control” implies “setting item”.

### EMBODIMENTS

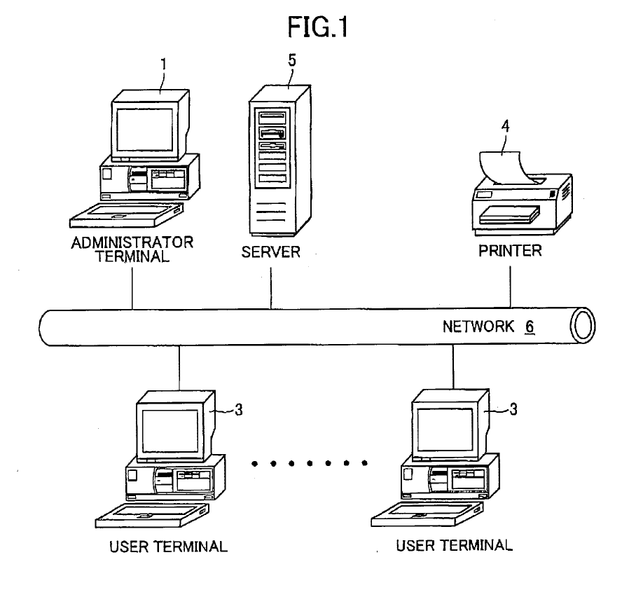

A setting device according to a first embodiment of the present invention will be described in detail with reference to FIG. 1 through 19. With reference to FIG. 1, description will be made with respect to a schematic configuration of a print management system 2 set up by an administrator terminal 1 equivalent to a setting device.

As shown in FIG. 1, the print management system 2 is basically configured with the administrator terminal 1, a plurality of user terminals 3, a printer 4 as a device, and a server 5. Further, the administrator terminal 1, the user terminals 3, the printer 4, and the server 5 are connected among each other via a network 6, such as an internal LAN, establishing two-way communication.

The administrator terminal 1 is a personal computer (hereinafter referred to as PC) used by an administrator managing the print management system 2. The administrator terminal 1 includes a control part, an input part, an output part, and an auxiliary storage part. The control part includes a CPU, a ROM, and a RAM. The input part includes a keyboard and a pointing device. The output part includes a display. The auxiliary storage part includes a non-volatile storage device such as a hard disk. The administrator terminal 1 is equipped with Windows (registered trademark), Linux (registered trademark), and Mac OS (registered trademark) as an operating system (OS). Basic functions, including an input/output function and an access function, commonly used through an application are provided by the OS. The input/output function includes a keyboard input and a screen output. The access function is for accessing a memory as a main storage part and the hard disk as the auxiliary storage part. Detailed description of each of the functions provided by each OS itself will be omitted, since the functions are publicly known.

Then, the administrator terminal 1 creates a setting information file for updating setting of a printer driver that controls the printer 4 from a user terminal 3 side to carry out printing. Here, the setting information file is a file for changing allocation information of controllers (setting items) allocated in a plurality of setting screens for changing a control condition of a printer. More specifically, a type of the setting screen in which the controllers are allocated and position coordinates of the controllers allocated in the setting screen are updated. Further, addition and deletion of the setting screen is also updated.

On the other hand, the user terminal 3 is a PC used by the user for performing printing operation with the printer 4. Then, similar to the administrator terminal 1, the user terminal 3 includes a control part, an input part, an output part, and an auxiliary storage part. The control part includes a CPU, a ROM, and a RAM. The input part includes a keyboard and a pointing device. The output part includes a display. The auxiliary storage part includes a non-volatile storage device such as a hard disk. Further, basic functions commonly used by various types of applications are provided by the OS.

The user terminal 3 downloads a printer driver stored in the server 5 and installs the same, thus enabling printing control to the printer 4. Further, in the same manner, the user terminal 3 downloads the setting information file stored in the server 5, and installs the same. Therefore, a plurality of the setting screens provided by the printer driver are updated to the setting screens intended by the administrator side.

Further, the printer 4 is a network printer connected to the network and shared so as to be available for a plurality of the users. Thus, the printer 4 carries out printing upon receiving instruction from each of the user terminals 3 connected via the network 6. A plurality of the printers 4 are available in the network. Further, a local printer locally connected to the user terminal 3 through a parallel cable or a universal serial bus (USB) cable can be used in stead of the network printer.

Further, the server 5 is accessible by the administrator terminal 1 and the user terminal 3. The server 5 stores the setting information file created in the administrator terminal 1 and a printer driver. Alternatively, the setting information file and the printer driver can be provided from the administrator terminal 1 to the user terminal 3 through a storage medium such as a CD-ROM without intervention of the server 5.

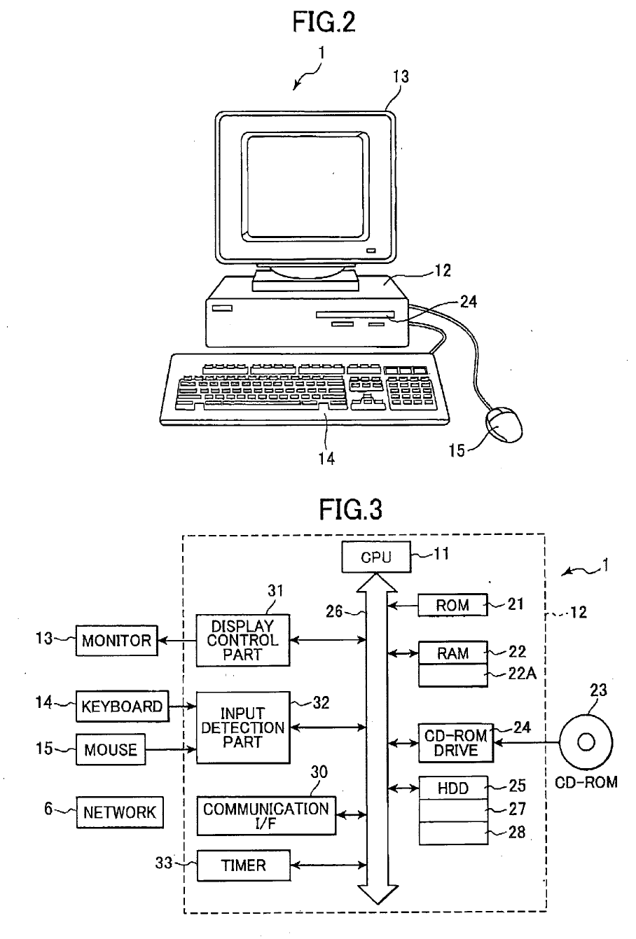

Next, a schematic configuration of the administrator terminal 1 will be described with reference to FIGS. 2 and 3. As shown in FIG. 2, the administrator terminal 1 includes a main body 12, a monitor 13, a keyboard 14, and a mouse 15. The main body 12 includes a CPU 11 (FIG. 3). Each of the monitor 13, the keyboard 14, and the mouse 15 is connected to the main body 12 by a connection cable. Further, the administrator terminal 1 is provided with a LAN card (not shown) and a wireless LAN adaptor (not shown) so as to be connected to the network 6.

Next, an electric configuration of the administrator terminal 1 will be described with reference to FIG. 3. As shown in FIG. 3, the administrator terminal 1 is provided with the CPU 11 executing a controlling routine in the administrator terminal 1. The CPU 11 is connected, through a bus 26, to a ROM 21, a RAM 22, a CD-ROM drive 24, and an HDD 25. The ROM 21 stores a program such as BIOS executed by the CPU 11. The RAM 22 temporarily stores a variety of arithmetic calculation results calculated by the CPU 11. The CD-ROM drive 24 is adapted to receive a CD-ROM 23 which is a data-storage medium for retrieving the data. The HDD 25 is a data storage device. The RAM 22 is provided with various memory regions such as a work area 22A.

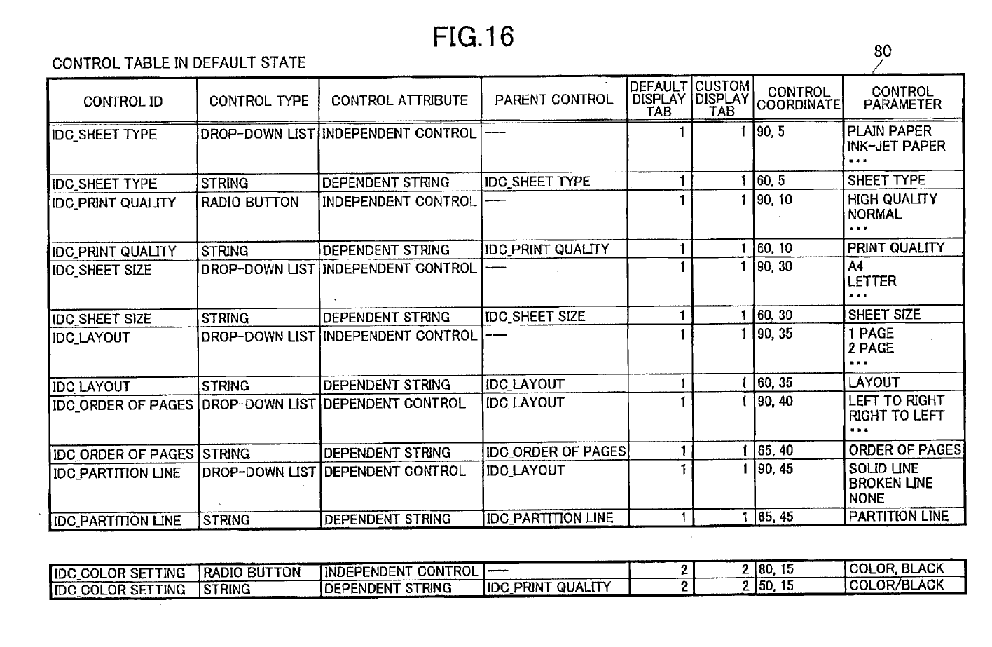

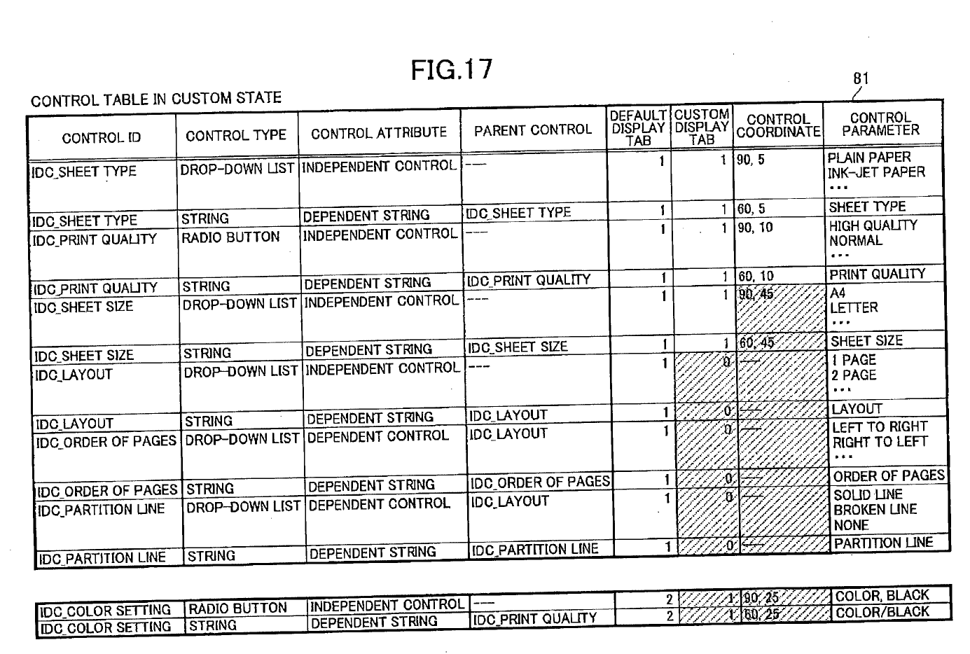

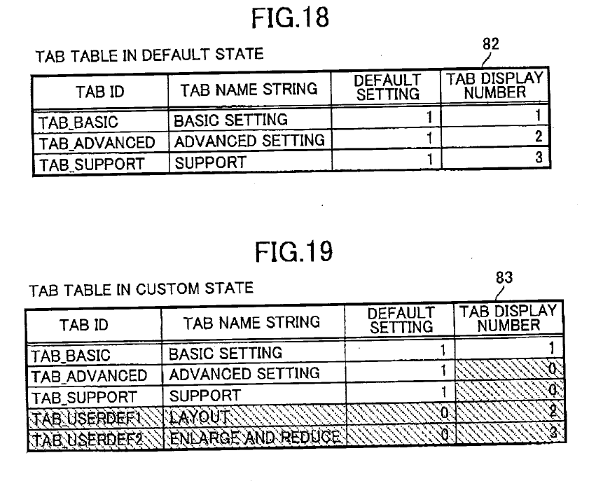

The HDD 25 is provided with an allocation information setting program storage area 27 and a program-related information storage area 28. The allocation information setting program storage area 27 stores an allocation information setting program executed in the administrator terminal 1 and setting allocation information of the setting items (controllers) allocated in the setting screen. The program-related information storage area 28 stores information, such as setting, an initial value, and data necessary for execution of a program. The program-related information storage area 28 stores therein information such as a setting item table (FIGS. 16 and 17) and a tab table (FIGS. 18 and 19) for default setting and custom setting those described later.

Further, the CPU 11 is connected to a communication I/F 30, a display control part 31, and an input detection part 32 through the bus 26. The communication I/F 30 is used for communication with external equipment such as the printer 4 and the server 5. The display control part 31 controls the monitor 13 for displaying a screen where an operation screen is displayed to the user. The input detection part 32 is connected to the keyboard 14 and the mouse 15 used for data input by the user, and carries out detection of such input. Alternatively, the administrator terminal 1 can be provided with a flexible disc drive (not shown), a audible sound input/output part, and a variety of types of interfaces.

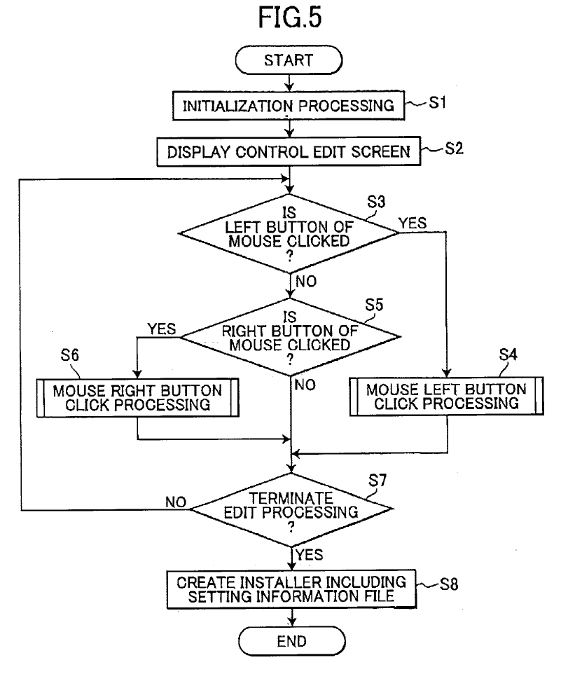

The CD-ROM 23 stores an allocation information setting program (FIGS. 5 to 11) described later and setting and data those used at the time of executing this program. At the time of installation, such program, setting, and data are stored in the allocation information setting program storage area 27 and the program-related information storage area 28 provided in the HDD 25 from the CD-ROM 23. Incidentally, allocation information setting program, setting and data can be acquired into the administrator terminal 1 by storage mediums such as a flexible disc and an MO other than CD-ROM 23, or can be downloaded from a server through an internet line. Further, the CPU 11 is connected to a timer 33 through the bus 26.

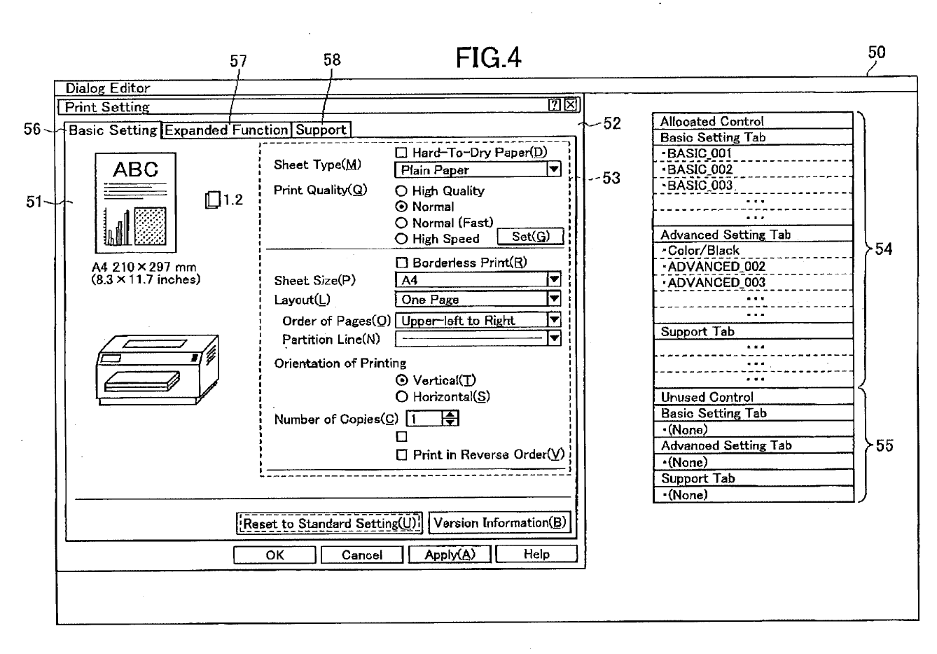

Next, description will be made with reference to FIG. 4 with respect to the allocation information setting application activated by execution of the allocation information setting program in the administrator terminal 1. Here, when the allocation information setting application is activated in the administrator terminal 1, a setting item edit screen 50 is displayed on the monitor 13, and input and instruction are carried out by operating the keyboard 14 and the mouse 15.

As shown in FIG. 4, the setting item edit screen 50 is configured with a setting screen display area 52, an allocated setting item display area 54, and an unallocated setting item display area 55. The setting screen display area 52 is adapted to switchingly display one of a plurality of setting screens 51 (three screens of “Basic Setting”, “Expanded Function”, and “Support”). The allocated setting item display area 54 displays a list of names of setting items 53 already allocated on the plurality of setting screens 51. The unallocated setting item display area 55 displays a list of names of the setting items 53 not allocated in any of the plurality of setting screens 51.

Here, the setting screen display area 52 displays one of the setting screens 51 among the plurality of setting screens 51 used in the printer driver. Further, by clicking one of tabs 56 to 58 with a cursor, the current setting screen 51 displayed on the setting screen display area 52 can be switched to other setting screen. For example, when the tab 56 of “Basic Setting” is clicked, the setting screen 51 of “Basic Setting” is displayed. Further, when the tab 57 of “Expanded Function” is clicked, a setting screen of “Expanded Function” (not shown) is displayed. Further, when the tab 57 of “Support” is clicked, a setting screen of “Support” (now shown) is displayed. At the time of activation of the allocation information setting application, a setting screen associated with the leftmost tab (the setting screen of “Basic Setting” in FIG. 4) is displayed first.

In the setting screen 51, a plurality of the setting items (controllers) 53 are allocated based on the setting item table (FIGS. 16 and 17). For example, in the setting screen 51 of “basic Setting” shown in FIG. 4, each of the setting items 53 of “Sheet Type”, “Print Quality”, “Sheet Size”, “Layout”, “Page Order”, and “Partition Line” is allocated. Types of each of the setting items 53 include a plurality of types including letter, a drop-down list, and a radio button. Further, with respect to setting items relating to each other, such as the letter of “Sheet Type” and the drop-down list of “Sheet Type”, a dependency relationship is set so that these setting items are not allocated at positions remote from each other. Further, by selecting a setting item indicated by a cursor, the selected setting item can be deleted from the setting screen currently displayed.

Further, the allocated setting item display area 54 is a display part that classifies a list of names of the setting items currently allocated into each of a plurality of the setting screens, and displays the classified list of the names in a list form. Then, the user can check an allocation state of the current setting items by referring to the allocated setting item display area 54. Further, by selecting a name of an optional setting item with the cursor and dragging and dropping the selected setting item to the setting screen 51, setting items allocated in other setting screen 51 can be allocated to the setting screen currently displayed.

Further, the unallocated setting item display area 55 is a display part that classifies names of setting items currently not allocated in any of the setting screens into a plurality of the setting screens to be allocated and displays the classified names of setting items in a list form. Then, the user can check an allocation state of the current setting items by referring to the unallocated setting item display area 55. Further, by selecting a name of an optional setting item with the cursor and dragging and dropping the selected setting item to the setting screen 51, setting items currently not allocated in any of the setting screens can be allocated to the setting screen 51 currently displayed.

Next, the allocation information setting processing executed in the administrator terminal 1 will be described with reference to FIG. 5. Processing shown in FIGS. 5 to 11 described below is executed by the CPU 11 of the administrator terminal 1.

First, when the allocation information setting program stored in the allocation information setting program storage area 27 is executed by the CPU 11, initialization processing is carried out in step S1 as shown in FIG. 5. In the initialization processing, each type of storage area (not shown) in the work area 22A of the RAM 22 is initialized.

Further, in step S2, the CPU 11 displays the setting item edit screen 50 (refer to FIG. 4) on the monitor 13 through a display control part 31. On the setting item edit screen 50, allocation information of positional coordinates and “visibility and hidden” of the setting items allocated in a plurality of the setting screen 51 can be changed based on operation of the administrator. Further, a setting information file for updating the printer driver to the changed allocation information of the setting items can be created. Thereafter, the process proceeds to step S3.

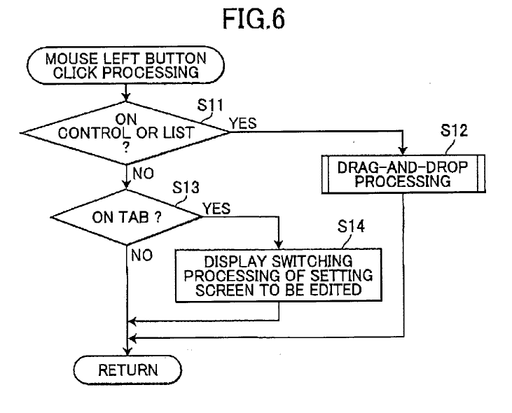

In step S3, determination is made as to whether or not a left button of the mouse 15 is clicked. Then, in case the left button of the mouse 15 is determined to be clicked (S3: YES), the process proceeds to step S4, and mouse left button click processing (FIG. 6) which will be described later is carried out. On the other hand, in case the left button of the mouse 15 is determined not to be clicked (S3: NO), the process proceeds to step S5.

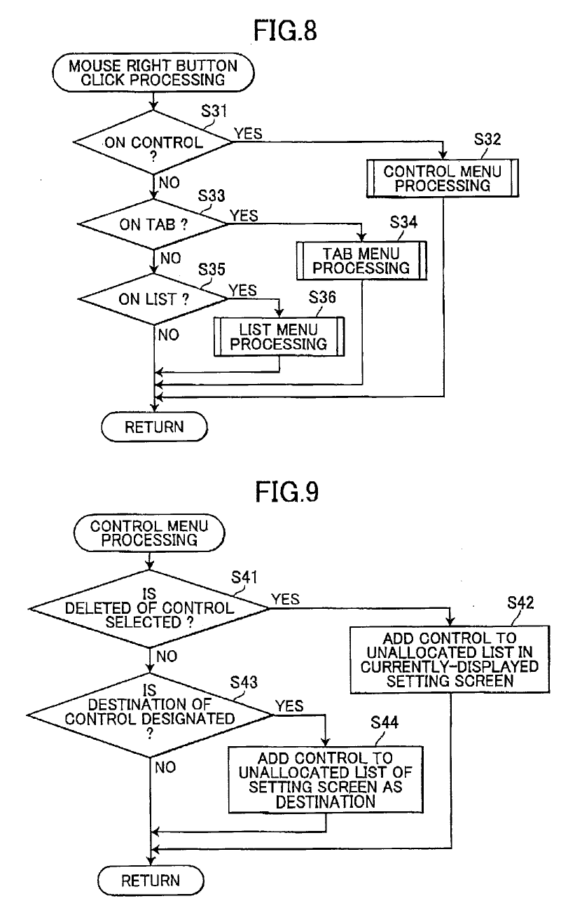

In step S5, judgment is made as to whether or not a right button of the mouse 15 is clicked. Then, in case the right button of the mouse 15 is determined to be clicked (S5: YES), the process proceeds to step S6 and mouse right button click processing (FIG. 8) described later is carried out. On the other hand, in case the right button of the mouse 15 is also determined not to be clicked (S5: NO), the process proceeds to step S7.

In step S7, the CPU 11 determines whether edit processing of the setting screen 51 of the printer driver is terminated or not. The edit processing of the setting screen 51 of the printer driver is terminated when the administrator carries out specific operation. Then, in case the edit processing of the setting screen 51 of the printer driver is determined to be terminated (S7: YES), an installer including a setting information file reflecting an update content up to the present is created (S8). Then, the created installer is uploaded to the server 5 through the network 6, and becomes in a state where the installer can be downloaded at the user terminal 3.

Here, the following four types are conceivable as a method of installing a setting information file to the user terminal 3.

(1) An install program for installing the setting information file and the printer driver in the user terminal 3 at the same time is created in step S8, and the setting information file is also installed in the user terminal 3 at the same time as installation of the printer driver.

(2) In step S8, the setting information file is transmitted to and stored in the printer 4 instead of creating the install program. Further, the printer driver to be installed in the user terminal 3 is equipped with an AutoDetect function. The AutoDetect processing is carried out to the subject printer 4 to obtain the setting information file and carry out update processing of the setting information.

(3) In step S8, the setting information file is transmitted to and stored in the server 5 in place of creation of the install program. Further, a print setting update program is registered in a resident program of the user terminal 3. The resident program obtains the setting information file on the server 5 at the time of log-in processing of the user terminal 3, and update processing of the setting information is carried out.

(4) In step S8, in place of the creation of the installation program, the setting information file is transmitted to and stored in a domain server that distributes a patch to the user terminal 3 participating in a domain. Then, the setting information file is installed in the user terminal 3 by a system of distributing the patch. Accordingly, the setting screen of the printer driver to be displayed in the user terminal 3 becomes a setting screen intended by the administrator side.

On the other hand, in case the edit processing of the setting screen of the printer driver is determined to be carried out continuously in the step S7 (S7: NO), the processing returns to step S3 to continue editing of the setting screen of the printer driver.

Next, the mouse left button click processing executed in the step S4 will be described with reference to FIG. 6. Here, the mouse left button click processing will be executed in case the left button of the mouse 15 is clicked in a state where the control edit screen 50 is displayed on the monitor 13.

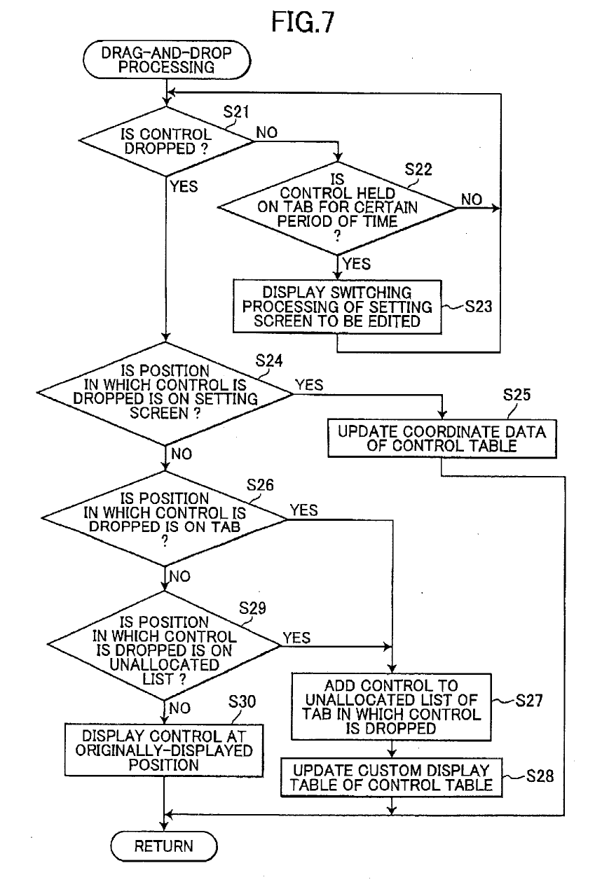

First, in step S11, the CPU 11 determines a position at which the left button of the mouse is clicked. The click position is one of the following: (1) any of the setting items 53 displayed on the setting item edit screen 50, (2) a list of setting items displayed in the allocated setting item display area 54 (refer to FIG. 4), and (3) a list of setting items displayed in the unallocated setting item display area 55. Then, in case the CPU 11 determines that the left button is clicked at any one of the locations of the above (1) to (3) (S11: YES), the process proceeds to step S12. Then, drag-and-drop processing (FIG. 7) described later with respect to the clicked setting item 53 and list is carried out.

On the other hand, in case the left button is determined to be clicked at a position other than the above (1) to (3) (S11: NO), the process proceeds to step S13. Then, in step S13, the CPU 11 determines whether the click position of the left button of the mouse is (4) at any one of the tabs 56 to 58 of a plurality of the setting screens.

As a result, in case the left button of the mouse is determined to be clicked at the position (4) (S13: Yes), the process proceeds to step S14, and the setting screen to be edited is switched. Specifically, the setting screen corresponding to the clicked tab is newly displayed on the setting screen display area 52. On the other hand, in case the left button is determined to be clicked at a position other than the above (1) to (4) (S13: NO), the routine proceeds into the determination processing of step S7 without performing processing.

Next, description will be made with respect to the drag-and-drop processing executed in the above-described step S12 with reference to FIG. 7. Here, the drag-and-drop processing is processing executed in case the left button is clicked on any of the setting items 53 and a list displayed in the setting item edit screen 50.

First, whether the CPU 11 determines whether a selected object is dropped or not in step S21. Then, in case the selected object is determined not to be dropped, that is, is determined to be being dragged (S21: NO), judgment is made as to whether the selected object is held for a certain period of time on the tabs 56 to 58 (S22).

Then, in case the selected object is held for a certain period of time on the tabs 56 to 58 (S22: YES), the process proceeds to step S23 and the setting screen to be edited is switched. More specifically, the setting screen corresponding to the tab having the selected object held thereon is newly displayed on the setting screen display area 52. Thereafter, the processing returns to step S21. On the other hand, in case the selected object is determined not to be held for a certain period of time on the tabs 56 to 58 (S22: NO), the processing returns to step S21 without switching the setting screen.

On the other hand, in case the selected object is determined to be dropped (S21: YES), the process proceeds to step S24, where determination is made as to whether or not a position where the selected object is dropped is in the setting screen 51 displayed in the setting screen display area 52.

As a result, in case the position where the selected object is dropped is determined to be in the setting screen 51 displayed in the setting screen display area 52 (S24: YES), setting item coordinate data of the setting item table (FIGS. 16 and 17) is updated so as to allocate setting item of the selected object at the position where the selected object is dropped (S25).

On the other hand, in case the position where the selected object is dropped is considered not to be in the setting screen 51 displayed in the setting screen display area 52 (S24: NO), determination is made as to whether or not the position where the selected object is dropped is on the tabs 56 to 58 of the setting screens (S26).

Then, the position where the selected object is dropped is determined to be on the tabs 56 to 58 of the setting screens 51 (S26: YES), a list of setting items of the selected object is added to the unallocated setting item display area 55 (refer to FIG. 4) of the setting screen corresponding to the tab where the selected object is dropped (S27). Subsequently, a custom display tab of the setting item table (FIGS. 16 and 17) is updated (S28).

On the other hand, in case the position where the selected object is dropped is determined not to be on the tabs 56 to 58 of the setting screens (S26: NO), determination is made as to whether or not the position where the selected object is dropped is on a list of the unallocated setting item display area 55 (S29).

Then, in case the position in which the selected object is dropped is determined to be on the list of the unallocated setting item display area 55 (S29: YES), a list of the setting items of the selected object is added to the unallocated setting item display area 55 in which the selected object is dropped (S27). The unallocated setting item display area 55 is classified into each of the setting screens in a list form. Therefore, the tabs of the setting screens to be added with the list of the setting items is determined by the position to which the selected object is dragged. Thereafter, the custom display tab of the setting item table (refer to FIGS. 16 and 17) is updated (S28).

On the other hand, in case the position at which the selected object is dropped is determined not to be on the list of the unallocated setting item display area 55 (S29: NO), the setting items 53 and the list to be selected are displayed at an originally displayed position (S30). In the first embodiment, a plurality of setting items and lists displayed on the setting item edit screen 50 can be selected at once, and can be dragged to and dropped at a predetermined position.

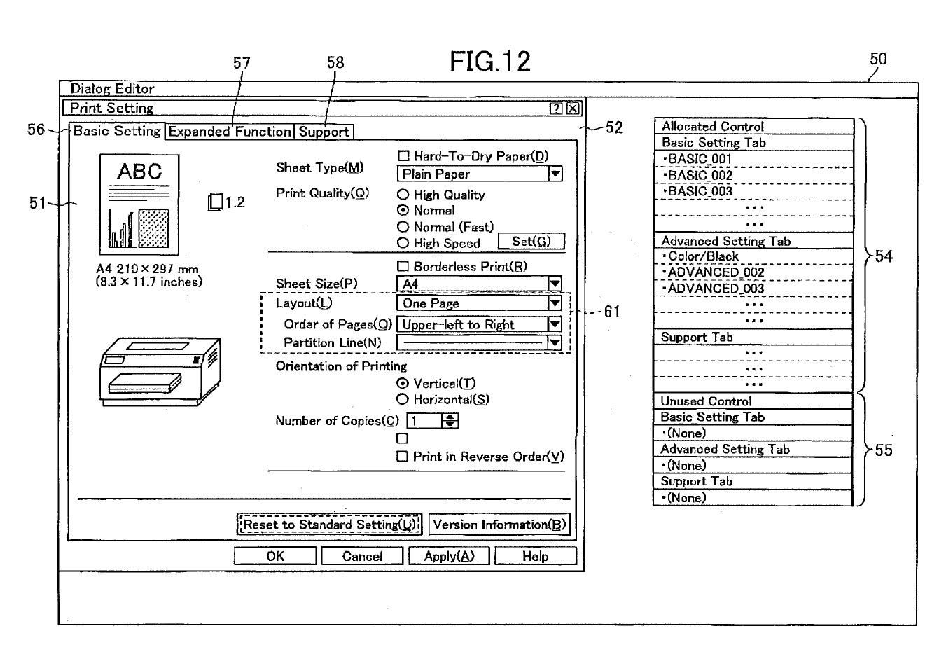

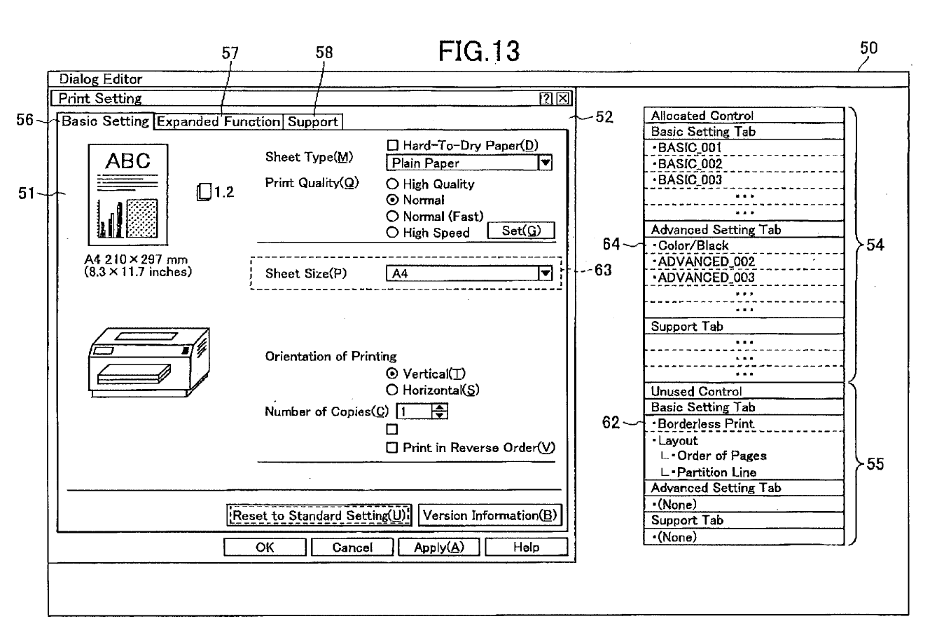

Next, the drag-and-drop processing will be described in more detail. FIGS. 12 to 15 are figures showing examples of the setting item edit screen 50 in which the drag-and-drop processing is carried out. For example, FIG. 13 is a view showing the setting item edit screen 50 after setting item 61 of “Layout” in the setting item edit screen 50 shown in FIG. 12 are dragged to and dropped at the unallocated setting item display area 55. As shown in FIGS. 12 and 13, the setting item 61 of “Layout” dragged and dropped is deleted from the setting screen 51, and added to a list 62 of “Basic Setting Tab” of the unallocated setting item display area 55.

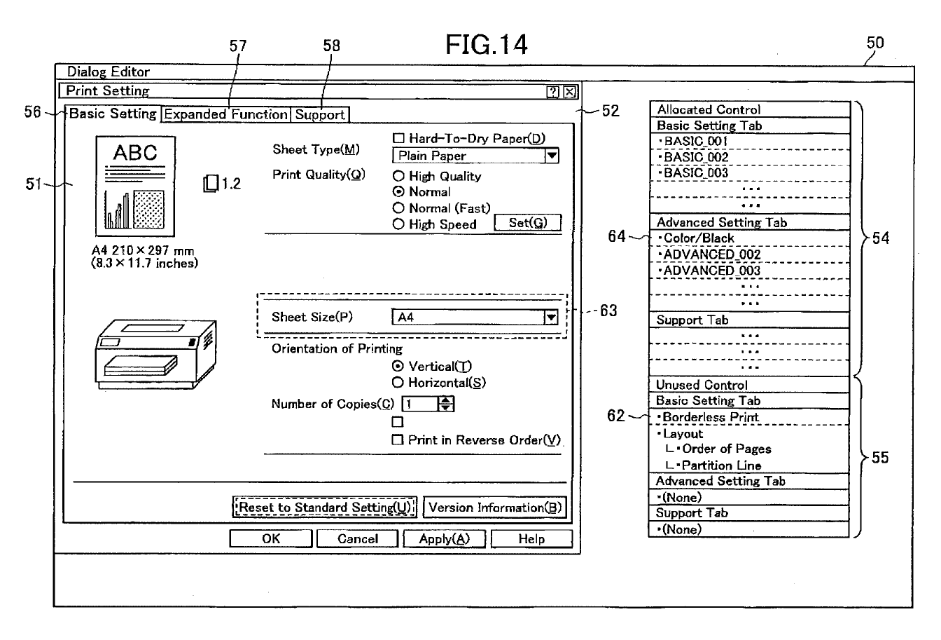

Next, FIG. 14 is a view showing the setting item edit screen 50 after a setting item 63 of “Sheet Size” in the setting item edit screen 50 shown in FIG. 13 is dragged to and dropped at a lower position in the same setting screen 51. As shown in FIGS. 13 and 14, the position of the setting item 63 of “Sheet Size” dragged and dropped is changed to the lower position to which the control 63 is dragged.

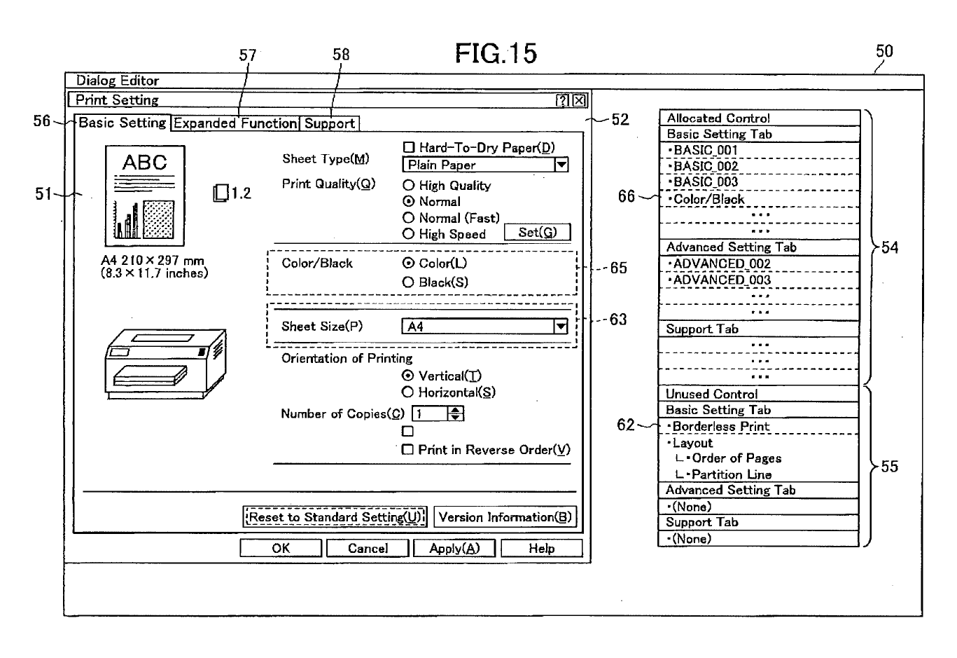

Further, FIG. 15 is a view showing the setting item edit screen 50 after a list 64 of “Color/Monochrome” allocated under “Advanced Settings Tab” of the allocated setting item display area 54 in the setting item edit screen 50 shown in FIG. 14 is dragged to and dropped in a free space above the setting item 63 of “Sheet Size” in the setting screen 51. As shown in FIGS. 14 and 15, a setting item 65 corresponding to the list 64 of “Color/Black” dragged and dropped is newly allocated at a position to which the list 64 is dragged in the setting screen 51. Further, the list 64 of “Color/Monochrome” displayed in the allocated control display area 54 is deleted.

Next, a specific example of the setting item table configuring the setting information file will be described with reference to FIGS. 16 and 17. Here, the setting item table is a table that stores the setting information with respect to all setting items which can be allocated in each of the setting screens. FIG. 16 is a view showing a setting item table 80 in a default state corresponding to FIG. 12. FIG. 17 is a view showing a setting item table 81 in a custom state corresponding to FIG. 15.

As shown in FIGS. 16 and 17, by setting the setting item 61 of “Layout” in the setting item edit screen 50 to be “hidden”, each of “Custom Display Tab” corresponding to the setting items 61 of “Layout” is updated from “1 to “0”. Further, by changing allocation of the setting item 63 of “Sheet Size” in the setting item edit screen 50, each of “Control Coordinate” corresponding to the setting item 63 of “Sheet Size” is changed from “90, 30” to “90, 45”, and from “60, 30” to “60, 45”.

Further, by changing allocations of the setting items 65 of “Color/Monochrome” are changed from the setting screen of “Expanded Function” to the setting screen of “Basic Setting” in the setting item edit screen 50, each of “Custom Display Tab” corresponding to the setting items 65 of “Color/Monochrome” is updated from “2” to “1”.

Next, the mouse right button click processing executed in the step S6 will be described based on FIG. 8. Here, the mouse right button click processing will be executed in case the right button of the mouse 15 is clicked in a state the setting item edit screen 50 is displayed on the monitor 13.

First, in step S31, the CPU 11 determines whether a position where the right button of the mouse is clicked is on any one of the setting items 53 displayed in the setting item edit screen 50. Then, in case the right button is determined to be clicked on any one of the setting items 53 (S31: YES), the process proceeds to step S32, and setting item menu processing (FIG. 9) described later with respect to the clicked setting item 53 is carried out.

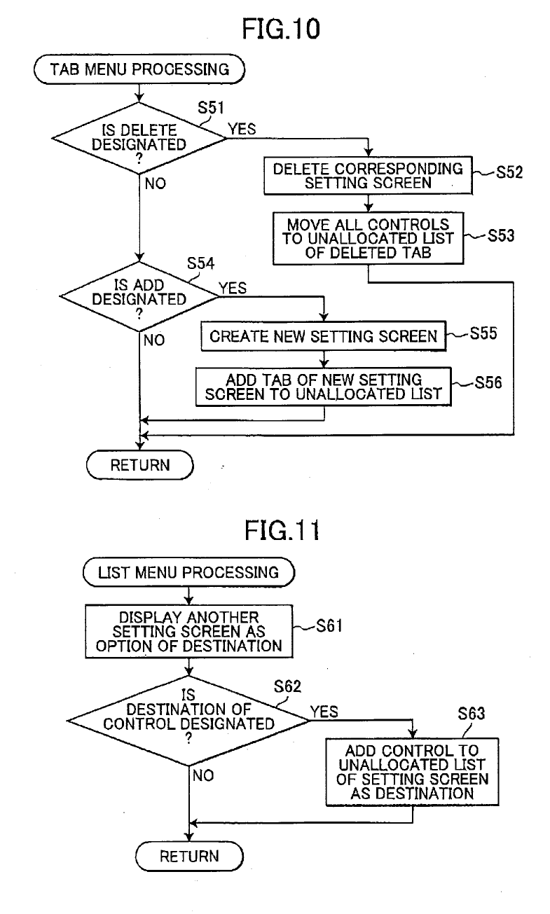

On the other hand, in case the right button is determined not to be clicked on the setting items 53 (S31: NO), the process proceeds to step S33. Then, in step S33, the CPU 11 determines whether the position where the right button of the mouse is on one of the tabs 56 to 58 of a plurality of the setting screens. As a result, in case the right button is determined to be clicked on one of the tabs 56 to 58 of the setting screens (S33: YES), the process proceeds to step S34 where tab menu processing (FIG. 10) described later with respect to the clicked tab will be carried out.

Further, in case the right button is determined to be not clicked on any one of the tabs 56 to 58 (S33: NO), the process proceeds to step S35. Then, in step S35, the CPU 11 determines whether or not a position where the right button of the mouse is clicked is on a list of setting items displayed in the allocated setting item display area 54 or the unallocated setting item display area 55. As a result, in case the right button is determined to be clicked on the list (S35: YES), the process proceeds to step S36 and list menu processing (FIG. 11) described later with respect to the clicked list is carried out. On the other hand, in case the right button is determined to be not clicked on the list either (S35: NO), the process proceeds directly to the determination processing of step S7.

Next, the setting item menu processing executed in the step S32 will be described with reference to FIG. 9. Here, the setting item menu processing is executed in case the right button of the mouse 15 is clicked with respect to any one of the setting items 53 displayed in the setting item edit screen 50.

First, in step S41, the CPU 11 determines whether a menu of “Delete” is selected in a menu screen (not shown) displayed by clicking the right button of the mouse. Then, in case the menu of “Delete” is determined to be selected (S41: YES), the selected setting item 53 is deleted from the setting screen 51 displaying the selected setting item 53. Then, a list of deleted setting items is added to a tab of the currently-displayed setting screen in the unallocated setting item display area 55 (S42). On the other hand, in case the menu of “Delete” is determined not to be selected (S41: NO), then determination is made as to whether or not any one of menus of “Move to Basic Setting”, “Move to Expanded Function”, and “Move to Support” displayed in the menu screen is selected (S43).

Then, in case any one of the menus of “Move to Basic Setting”, “Move to Expanded Function”, and “Move to Support” is determined to be selected (S43: YES), the selected setting item 53 is deleted from the setting screen 51. Further, a list of deleted setting items is added to a tab of the designated setting screen in the unallocated setting item display area 55 (S44). On the other hand, in case any one of the menus of “Move to Basic Setting”, “Move to Expanded Function”, and “Move to Support” is determined not to be selected (S43: NO), the process directly proceeds to the determination processing step S7.

Next, the tab menu processing executed in the step S34 will be described with reference to FIG. 10. Here, the tab menu processing will be executed in case the right button of the mouse 15 is clicked with respect to any one of the tabs 56 to 58 displayed in the setting item edit screen 50. First, in step S51, the CPU 11 determines whether the menu of “Delete” is selected in the menu screen (not shown) displayed by clicking the right button of the mouse.

Then, in case the menu of “Delete” is determined to be selected (S51: YES), the setting screen corresponding to the selected tab (for example, the setting screen of “Basic Setting” in case the tab 56 is selected) is deleted (S52), and all the setting items currently allocated in the setting screen are added to the list of the unallocated setting item display area 55 (S53). On the other hand, in case the menu of “Delete” is determined not to be selected (S51: NO), determination is made as to whether or not a menu of “Add” displayed in the menu screen is selected (S54).

Then, in case the menu of “Add” is determined to be selected (S54: YES), a new setting screen is created (S55), and a tab corresponding to the newly created setting screen is added to the unallocated setting item display area 55 (S56). On the other hand, in case the menu of “Add” is also determined not to be selected (S54: NO), the process directly proceeds to the determination processing S7.

Next, a specific example of a tab table configuring the setting information file will be described with reference to FIGS. 18 and 19. Here, the tab table is a table that stores setting information relating to the setting screen equipped in the printer driver. FIG. 18 is a view showing a tab table 82 in a default state including “Basic Setting”, “Advanced Setting”, and “Support” as shown in FIG. 12. FIG. 19 shows a view showing a tab table 83 in a custom state where two setting screens, “Advanced Setting” and “Support”, are deleted, and two setting screens, “Layout” and “Enlarge/Reduce”, are newly created.

As shown in FIGS. 18 and 19, upon deletion of the setting screens of “Advanced Setting” and “Support” in the tab menu processing (FIG. 10), each of “Tab Display Number” corresponding to “Advanced Setting” and “Support” is updated from “2” to “0”, and from “3” to “0”. Further, upon addition of the setting screens of “Layout” and “Enlarge/Reduce” in the tab menu setting (FIG. 10), lists corresponding to “Layout” and “Enlarge/Reduce” are added and “2” and “3” are set in “Tab Display Number”.

Next, the list menu processing executed in the step S36 will be described with reference to FIG. 11. Here, the list menu processing will be executed in case the right button of the mouse 15 is clicked with respect to any one of lists in the allocated setting item display area 54 and the unallocated setting item display area 55 displayed in the setting item edit screen 50.

First, in step S61, the CPU 11 displays the menu screen (not shown) displayed by clicking the right button of the mouse. In the menu screen, the menus of “Move to Basic Setting”, “Move to Expanded Function”, and “Move to Support” are displayed. Next, determination is made as to whether or not any one of the menus of “Move to Basic Setting”, “Move to Expanded Function”, and “Move to Support” displayed in the menu screen is selected (S62).

Then, in case any one of the menus of “Move to Basic Setting,”, “Move to Expanded Function”, and “Move to Support” is determined to be selected (S62: YES), the selected list is deleted from the allocated setting item display area 54 or the unallocated setting item display area 55 those currently displayed. Further, the selected list is added to a tab of the designated setting screen in the unallocated setting item display area 55 (S63). On the other hand, in case none of the menus of “Move to Basic Setting”, “Move to Expanded Function”, and “Move to Support” is determined be selected (S62: NO), the process directly proceeds to the determination processing of step S7.

As described above, in the administrator terminal according to the present embodiment, the allocation information setting application is activated by executing the allocation information setting program in the administrator terminal 1. Then, in the setting item edit screen 50 displayed in the monitor 13, a list of setting items displayed in the allocated setting item display area 54 or the unallocated setting item display area 55 is dragged to and dropped in the setting screen 51 displayed in the setting screen display area 52. In this manner, the allocation information is set so as to allocate corresponding setting items in the currently-displayed setting screen, and accordingly, allocation of setting items can be changed, at the administrator side, between or among a plurality of the setting screens. Accordingly, setting items frequently used can be reallocated for easier operation in accordance with a purpose of the user using the device, and usability can be improved.

Further, by selecting the setting item 53 allocated in the setting screen 51 displayed in the setting screen display area 52, the allocation information of the selected setting item 53 can be updated to allocation information not allocating the setting item in the displayed setting screen. Accordingly, setting items that are considered to be unnecessary for the user can be removed from the setting screen at the administrator side.

Further, by selecting a setting item from a list of setting items displayed in the unallocated setting item display area 55, the allocation information of the selected setting item can be updated to allocation information for newly allocating the setting item in the setting screen. Therefore, a setting item that becomes unnecessary in a plurality of the setting screens can be newly allocated in another setting screen at the administrator side. Accordingly, a setting item frequently used can be reallocated for easier operation in accordance with a purpose of the user using the device, and usability can be improved.

Further, by displaying a list of setting items which can be allocated in a plurality of the setting screens in the allocated setting item display area 54 and the unallocated setting item display area 55, and by selecting a setting item from the displayed list of the setting items, allocation information of the selected setting item can be updated to allocation information for allocating the setting item in the newly displayed setting screen. Therefore, a setting item that the administrator desires to allocate can be selected from the list of all setting items which can be allocated in a plurality of the setting screens at the administrator side. Accordingly, the administrator can set allocation of setting items between or among a plurality of the setting screens without switching operation of the setting screens, whereby operation efficiency can be improved.

Further, a plurality of setting items can be selected collectively. Therefore, operation efficiency on the administrator side with respect to the device driver including a number of setting items is improved.

Further, by dragging and dropping displayed setting items to and in the displayed setting screen, allocation information of the setting item is updated to allocation information allocating the setting item at a position where the setting item is dragged to and dropped in. Accordingly, allocation information of setting items can be updated easily during short period of time, and therefore working efficiency on the administrator side can be improved.

Further, a setting screen can be deleted and added. Therefore, in case there is a setting screen that is not necessary for the user, setting items in the setting screen do not need to be deleted from the administrator side, and setting per each setting screen is achievable. Further, in case a great number of setting items to be allocated are provided, large number of setting items can be orderly organized or arranged capable of being easily recognized by the user by increasing the number of setting screen.

Further, an installer including allocation information of setting items is created. Therefore, the device driver including setting item allocation desired by the administrator can be easily distributed to each user.

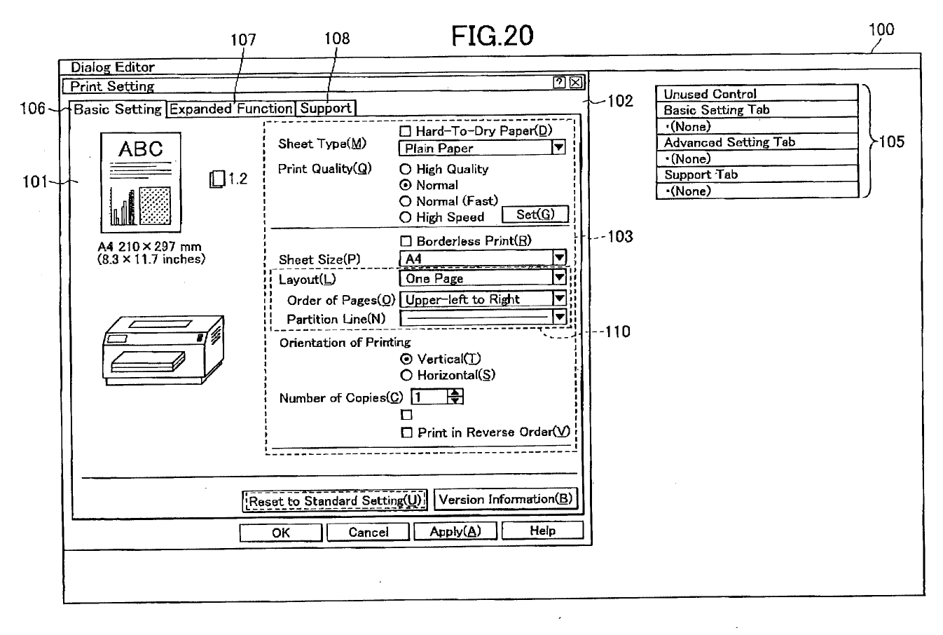

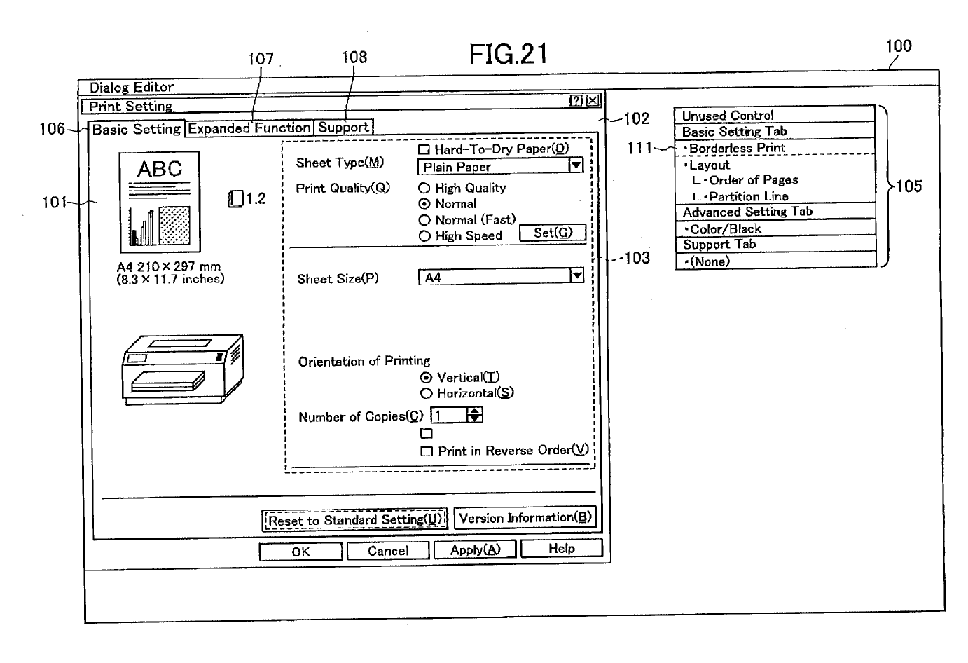

Next, an administrator terminal 1 according to a second embodiment of the present invention will be described with reference to FIGS. 20 and 21 in which like parts and components are designated by the same reference numerals as those shown in FIGS. 1 through 19.

A schematic configuration of the administrator terminal according to the second embodiment has a configuration almost identical to that of the administrator terminal 1 according to the first embodiment. Further, each type of processing executed in the administrator terminal according to the second terminal is also almost identical to that executed in the administrator terminal 1 of the first embodiment. However, the administrator terminal according to the second embodiment is different from the administrator terminal 1 according to the first embodiment in that the allocation information setting application is activated by executing the allocation information setting program, and the allocated setting item display area is not displayed but only an unallocated setting item display area 105 is displayed in a setting item edit screen 100 displayed on the monitor 13.

First, with reference to FIG. 20, description will be made with respect to the allocation information setting application activated upon execution of the allocation information setting program at the administrator terminal according to the second embodiment. FIG. 20 is a view of a setting item edit screen of the allocation information setting application.

Here, when the allocation information setting application is activated in the administrator terminal, the setting item edit screen 100 is displayed on the monitor 13, and input and instruction will be carried out by operation of the keyboard 14 and the mouse 15.

As shown in FIG. 20, the setting item edit screen 100 includes a setting screen display area 102 and an unallocated setting item display area 105. The setting screen display area 102 is adapted to switchingly display one of a plurality of setting screens 101 (three screens of “Basic Setting”, “Expanded Function”, and “Support” in the second embodiment). The unallocated setting item display area 105 displays a list of names of setting items 103 not allocated in any one of the plurality of setting screens 101.

Here, the setting screen display area 102 displays one of the setting screens 101 among the plurality of setting screens 101 used in the printer driver. Further, by clicking tabs 106 to 108 with a cursor, the current setting screen 101 displayed on the setting screen display area 102 can be switched to other setting screen. At the time of activation of the allocation information setting application, a setting screen of a leftmost tab (the setting screen of “Basic Setting” in FIG. 20) is displayed first.

Further, in the setting screen 101, a plurality of the setting items 103 are allocated based on the setting item table (FIGS. 16 and 17). For example, in the setting screen 101 of “Basic Setting” shown in FIG. 20, setting items 103 of “Sheet Type”, “Print Quality”, “Sheet Size”, “Layout”, “Page Order”, and “Partition Line” are allocated. A variety of types of setting items 103 are provided such as letter, a drop-down list, and a radio button. Further, with respect to setting items relating to each other, such as letter of “Sheet Type” and a drop-down list of “Sheet Type”, a dependency relationship is set so that these setting items are not allocated at positions remote from each other. Further, by selecting a setting item indicated by a cursor, the selected setting item can be deleted from the setting screen currently displayed.

The unallocated setting item display area 105 is a display part that classifies names of setting items currently not allocated in any of the setting screens into a plurality of the setting screens and displays the classified names of setting items in a list form. Thus, the user can recognize an allocation state of the current setting items by referring to the unallocated setting item display area 105. Further, by selecting a name of an optional setting item with the cursor and dragging and dropping the selected setting item to the setting screen 101, setting items currently not allocated in any of the setting screens can be allocated in the setting screen 101 currently displayed.

Next, the drag-and-drop processing (FIG. 7) executed in the administrator terminal according to the second embodiment will be described in more detail with specific examples. FIG. 21 is a view showing the setting item edit screen 100 after a setting item 110 of “Layout” is dragged to and dropped in the unallocated setting item display area 105 in the setting item edit screen 100 shown in FIG. 20. As shown in FIGS. 20 and 21, the setting item 110 of “Layout” dragged and dropped is deleted from the setting screen 101, and added to a list 111 of “Basic Setting Tab” in the unallocated setting item display area 105.

As described above, in the administrator terminal according to the second embodiment, the allocation information setting application is activated upon execution of the allocation information setting program at the administrator terminal. Then, in the setting item edit screen 100 displayed in the monitor 13, a list of setting items displayed in the unallocated setting item display area 105 is dragged to and dropped in the setting screen 101 displayed in the setting screen display area 102. In this manner, the allocation information is set so as to allocate corresponding setting items in the currently-displayed setting screen. Accordingly, allocation of setting items can be changed between or among a plurality of the setting screen at the administrator side. Consequently, setting items frequently used can be reallocated easily in accordance with a demand of the user, to thus enhance usability.

While the invention has been described in detail and with reference to specific embodiments thereof, it would be apparent to those skilled in the art that various changes and modifications may be made therein without departing from the spirit and scope of the invention.

For example, the allocated setting item display area 54 and the unallocated setting item display area 55 are both displayed in the setting item edit screen 50 in the first embodiment. Also, only the unallocated setting item display area 105 is displayed in the setting item edit screen 100 in the second embodiment. However, alternatively, only the allocated setting item display area 54 can be displayed in the setting item edit screen 50.

Further, the present invention can be applied to device drivers other than the printer driver, such as a scanner driver and a Facsimile driver. Furthermore, a storage medium storing the above described program instructions executable on a computer also belongs to the present invention.

1. A setting device for setting, in a device driver provided with a plurality of setting screens each changing a control condition of a targeting device, allocation information of a setting item to be allocated in one of the setting screens, the setting device comprising:
allocation information storing part that stores allocation information of a setting item to be allocated in any of the plurality of setting screens;
setting screen display control part that displays any of the plurality of setting screens in a display region;
setting item allocating part that allocates the setting item in the setting screen displayed in the display region in accordance with the stored allocation information of the setting item;
unallocated setting item selecting part that selects a setting item not allocated in the displayed setting screen; and
allocation information updating part that updates allocation information of the setting item selected by the unallocated setting item selecting part to a new allocation information for allocating the selected setting item in the displayed setting screen, allocation information of the setting item to be allocated in the setting screen of the device driver being set based on the updated allocation information.

2. The setting device according to claim 1, further comprising:
allocated setting item selecting part that selects a setting item allocated in the setting screen displayed in the display region; and
unallocated information updating part that updates allocation information of the selected setting item to a new allocation information avoiding allocation of the setting item in the displayed setting screen.

3. The setting device according to claim 2, further comprising unallocated list display control part that displays in the display region a list of the setting items updated to the new allocation information avoiding allocation of the setting items in the displayed setting screen by the unallocated information updating part, and
wherein the unallocated setting item selecting part selects the setting item from the list of the setting items displayed by the unallocated list display control part.

4. The setting device according to claim 3, further comprising list display control part that displays in the display region a list of setting items allocatable in the plurality of setting screens; and
wherein the unallocated setting item selecting part selects the setting item from the list of the setting items displayed by the list display control part.

5. The setting device according to claim 4, wherein the allocation information updating part updates, after a setting item displayed by one of the list display control part and the unallocated list display control part is dragged to and dropped in the displayed setting screen, the allocation information to a new allocation information allocating the dragged and dropped setting item in a dropped position of the setting screen.

6. The setting device according to claim 2, further comprising list display control part that displays in the display region a list of setting items allocatable in the plurality of setting screens; and
wherein the unallocated setting item selecting part selects the setting item from the list of the setting items displayed by the list display control part.

7. The setting device according to claim 2, wherein at least one of the unallocated setting item selecting part and the allocated setting item selecting part is configured to collectively select a plurality of setting items.

8. The setting device according to claim 1, further comprising deleting part that deletes any of the plurality of setting screens.

9. The setting device according to claim 1, further comprising creating part that creates a new setting screen.

10. The setting device according to claim 1, further comprising installer creating part that creates an installer including a file of updated allocation information of the setting items and file and a file of the device driver.

11. The setting device according to claim 1, wherein the device driver retrieves the updated allocation information of the setting item stored in the allocation information storing part.

12. A storage medium storing a set of program instructions installable in a computer, the program instruction setting, in a device driver provided with a plurality of setting screens each changing a control condition of a targeting device, allocation information of a setting item to be allocated in one of the setting screens, the set of program instructions comprising:
allocation information storing routine that stores allocation information of a setting item to be allocated in any of the plurality of setting screens;
setting screen display control routine that displays any of the plurality of setting screens in a display region;
setting item allocating routine that allocates the setting item in the setting screen displayed in the display region in accordance with the stored allocation information of the setting item;
unallocated setting item selecting routine that selects a setting item not allocated in the displayed setting screen; and
allocation information updating routine that updates allocation information of the setting item selected by the unallocated setting item selecting routine to a new allocation information for allocating the selected setting item in the displayed setting screen, allocation information of the setting item to be allocated in the setting screen of the device driver being set based on the updated allocation information.
